(19) United States
(12) Patent Application Publication
(10) Pub. No.: US 2025/0371485 A1
(43) Pub. Date: Dec. 4, 2025

(54) MACHINE LEARNING MODELS TO EVALUATE PLACEMENT ACCURACY FROM IMAGE DATA

(71) Applicant: Veho Tech, Inc., Claymont, DE (US)

(72) Inventors: Austin Michael Sparkman, Minneapolis, MN (US); Patrick Poteet, Littleton, CO (US); Timothy Mathison, Minneapolis, MN (US)

(73) Assignee: Veho Tech, Inc., Claymont, DE (US)

(21) Appl. No.: 19/227,079

(22) Filed: Jun. 3, 2025

Related U.S. Application Data
(60) Provisional application No. 63/655,978, filed on Jun. 4, 2024.

(51) Int. Cl. G06Q 10/0833; G06T 7/70; G06V 10/70

(52) U.S. Cl. CPC G06Q 10/0833; G06T 7/70; G06V 10/70; G06T 2207/20081

(57) ABSTRACT

A method may include identifying a package to be transported to a location based on a data structure including an identifier of the package, querying a database using the identifier of the package to retrieve placement instructions for the package, retrieving a placement image for the package in the location using a media identifier indicating a cloud storage location, executing a request generation engine to generate a request for a machine-learning model using the placement instructions and the placement image for the package, transmitting the generated request to the machine-learning model, receiving a response from the machine-learning model including a package placement score based on a position of the package, and transmitting the package placement score to a mobile device of a transport agent corresponding to the package.

### CROSS-REFERENCE TO RELATED APPLICATIONS

This application claims priority to U.S. Provisional Application No. 63/655,978, filed Jun. 4, 2024, which application is incorporated herein by reference.

### BACKGROUND

Maintaining accountability of delivery personnel can be a difficult task using traditional methods and systems. Proof-of-delivery images are a useful tool for verifying package delivery and compliance with delivery instructions. However, review of proof-of-delivery images is a time-consuming and inaccurate process.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Proof-of-delivery images may be used to evaluate whether a packages were delivered and whether the packages were delivered correctly, according to delivery instructions. Embodiments discussed herein provide for using machine-learning models to evaluate whether proof-of-delivery images include packages and whether the packages are delivered according to delivery instructions. In an example, a prompt engine parses delivery instructions to identify instructions related to package placement in order to generate a prompt for a large language model (LLM). The generated prompt includes a proof-of-delivery image and text based on the delivery instructions. The LLM generates a response to the prompt including a delivery score and an explanation for the delivery score. The score and explanation can be used to track delivery of packages, to monitor delivery statistics, and to inform drivers of whether their deliveries comply with delivery instructions.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is a block diagram of an example system for coordinating package delivery.

FIG. 2 is a block diagram of an example system for scoring package delivery using a large language model.

FIG. 3 is a block diagram of an example system for scoring package delivery using a package-recognition model.

FIG. 4 illustrates an example package delivery scoring data structure.

FIG. 5 is a flow chart of an example method for scoring package delivery using a machine-learning model.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Package delivery systems can involve complex logistics to ensure packages reach their intended destinations. Delivery drivers often receive instructions for package placement and handling to meet customer preferences. Proof-of-delivery images captured by drivers provide visual confirmation that packages were delivered according to specified instructions. Machine learning models, such as large language models, can process natural language and visual information to evaluate compliance with delivery instructions. Automated systems can use these models to analyze proof-of-delivery images and corresponding delivery instructions to assess delivery quality.

Conventional approaches for evaluating package delivery compliance rely on manual review of proof-of-delivery images by human operators. However, manual review processes can be time-consuming, inconsistent, and prone to human error. As delivery volumes increase, manual review becomes increasingly impractical to scale. Additionally, human reviewers may have difficulty consistently interpreting and applying diverse delivery instructions across large numbers of deliveries. Automated systems using traditional computer vision techniques can struggle to handle the variability in delivery scenarios and instructions.

The techniques described herein can provide systems and methods for evaluating package delivery using machine learning models. A delivery coordination system can obtain delivery instructions and a proof-of-delivery image for a package. The delivery coordination system can generate a prompt for a large language model based on the delivery instructions and proof-of-delivery image. The large language model can analyze the prompt to evaluate compliance with the delivery instructions.

In some implementations, the delivery coordination system can preprocess the delivery instructions to extract relevant placement and handling directives. The delivery coordination system can generate a prompt including the preprocessed instructions, the proof-of-delivery image, and formatting instructions for the desired response. The prompt can be transmitted to a large language model, which can generate a response including a package delivery score and supporting reasoning. The delivery coordination system can verify that the response follows a specified format template. The package delivery score can be transmitted to a mobile device of the delivery driver who submitted the proof-of-delivery image.

The techniques described herein can enable automated, consistent evaluation of package delivery compliance across large numbers of deliveries. By leveraging the natural language understanding and visual processing capabilities of large language models, the techniques can handle diverse delivery instructions and scenarios. The automated scoring approach can provide rapid feedback to delivery drivers to improve performance. The techniques can scale more efficiently than manual review processes while maintaining evaluation quality. Package delivery organizations can use the techniques to enhance delivery quality and customer satisfaction without requiring extensive human review resources.

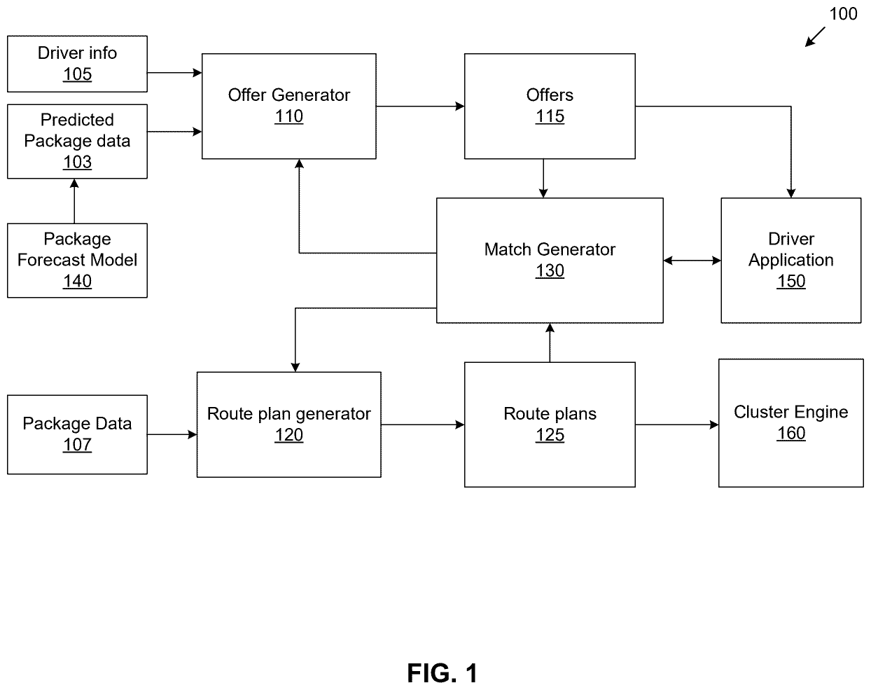

FIG. 1 is a block diagram of an example system 100 for coordinating package delivery. The system 100 includes an offer generator 110. The offer generator 110 may be a machine-learning model trained to generate offers 115. The offers 115 may be driver-facing offers to deliver packages. The offers 115 may each include one or more of a region, price, duration, and a number of packages. In some implementations, the offers 115 each one or more of a range of potential prices, a range of potential durations, and/or a range of a potential number of packages.

The offer generator 110 may receive as input predicted package data 103 and output the offers 115. The predicted package data 103 may include a prediction of one or more of a number of packages, destinations for packages, sizes of packages, and weights of packages. The predicted package data 103 may be based on historical package data as well as additional data such as weather, seasonal trends, and economic indicators. The predicted package data 103 may include predicted package volume for a future time period, before actual package volume is known. In some implementations, the predicted package data 103 may be generated by a package forecast model 140. The package forecast model 140 may be a machine-learning model. The package forecast model 140 may be trained using historical package data and/or additional data such as weather, seasonal trends, and economic indicators to generate the predicted package data 103. In an example, the package forecast model 140 is trained using a supervised training approach in which the package forecast model 140 is executed using as input historical data to generate a predicted package volume for a time period which is compared to an actual package volume for the time period. In this example, the package forecast model 140 is updated based on a difference between the predicted package volume and the actual package volume.

In some implementations, the offer generator 110 receives as input the predicted package data 103 as well as driver information 105. The driver information 105 may include driver vehicle information, such as vehicle size, vehicle height, vehicle capacity (e.g., in cubic feet), and other vehicle characteristics. In an example, the offer generator 110 receives as input the predicted package data 103 and vehicle capacity information and generates the offers 115 based on how many packages of the predicted package data 103 can fit in driver vehicles. The driver information 105 may include a ratio of successful deliveries performed by a driver, a delivery speed of the driver, a starting location of the driver, and/or prices of offers previously accepted by the driver.

The offer generator 110 may be trained using historical data. In an example, the offer generator 110 may be executed using as input historical data to generate offers for a historical time period, which offers are compared to actual, human-generated offers for the historical time period. In this example, the offer generator 110 is updated based on a difference between the generated offers for the historical time period and the actual offers for the historical time period. In some implementations, the offer generator 110 may be trained based on an acceptance rate of the offers 115. In an example, the offer generator 110 may be trained based on a speed at which the offers 115 are accepted. In an example, the offer generator 110 may be trained based on whether the offers 115 are accepted quickly enough to ensure timely delivery of packages.

The offers 115 may be provided to drivers using a driver application 150. The driver application 150 may a computer application (e.g., mobile application) which provides a user interface for drivers to view and accept the offers 115. The driver application 150 may display the offers 115 including prices, ranges of prices, region, numbers of packages, ranges of number of packages, durations, or ranges of durations. The drivers may, using the driver application 150, accept offers for current and/or future time periods. In an example, a driver accepts, using the driver application 150, an offer to deliver packages the same day when the packages are to be delivered. In an example, a driver accepts, using the driver application 150, an offer to deliver packages three days before when the packages are to be delivered. In an example, a driver accepts, using the driver application 150, an offer to deliver packages one week before when the packages are to be delivered.

The system 100 includes a route plan generator 120. The route plan generator 120 may be a machine-learning model which is executed using as input package data 107 to generate route plans 125. The package data 107 may be actual package data including a number of packages, delivery destinations of the packages, sizes and weights of the packages, and other package characteristics. The package data 107 may be received from a variety of sources. In an example, the package data 107 may be received using API calls from a plurality of merchants which need packages delivered, the API calls ingested to produce the package data 107 as input to the route plan generator 120. The route plans 125 may be routes through a delivery region. The route plans 125 may include routes for delivery drivers to take in delivering packages. The route plans 125 may be associated with packages of the package data 107 or generated based on the package data 107 but not associated with any specific packages of the package data 107. The route plans 125 may include break points representing points in the route plans where the route plans may be broken into smaller route plans if needed. In this way, portions of route plans may be moved between different route plans, providing flexibility in how packages are to be delivered.

The route plan generator 120 may receive as input the package data 107 and output the route plans 125. The route plan generator 120 may optimize the route plans 125 based on package density (e.g., density of deliveries in an area) and distance from a pickup location (e.g., distance from a warehouse where drivers pick up packages).

The route plan generator 120 may be trained to generate and optimize the route plans 125 using a supervised or semi-supervised training approach. The route plan generator 120 may be trained using historical data. In an example, the route plan generator 120 may be executed using historical data to generate route plans for a historical period which are compared to actual route plans (e.g., human-generated route plans) used for the historical period. In this example, the route plan generator 120 is updated based on a difference between the actual route plans and the generated route plans. The route plan generator 120 may be updated based on delivery statistics. In an example, the route plan generator 120 generates the route plans 125, the route plans 125 are used by drivers to deliver packages, and delivery times of the packages are used to update the route plan generator 120. In this example, the route plan generator 120 may be updated, using the delivery times of the packages, to better optimize the route plans for time between stops as well as a total delivery time for the packages.

The route plan generator 120 may begin to generate the route plans 125 once the package data 107 begins to be received. The route plan generator 120 may dynamically generate and update the route plans 125 as the package data 107 is received. The offer generator 110 may begin to generate the offers 115 before the package data 107 begins to be received. The offer generator 110 may begin to generate the offers once the predicted package data 103 is generated/received. In this way, the offers 115 may be generated before the route plans 125. The offers 115 and route plans 125 may be dynamically generated and updated until package assignments are finalized and/or until drivers pick up the packages for delivery. In this way, the offers 115 may begin to be generated before the route plans 125 begin to be generated, and the offers 115 and the route plans 125 may be dynamically generated and updated until package assignments are finalized and/or until drivers pick up the packages for delivery.

The system 100 includes a match generator 130. The match generator 130 may be a machine-learning model which is executed using as input the offers 115 and the route plans 125 to generate pairs of offers and route plans. The offer and route plan pairs generated by the match generator 130 may include an offer of the offers 115 and one or more route plans of the route plans 125. The match generator 130 may generate the offer and route plan pairs based on characteristics of the offers 115 and the route plans 125.

The match generator 130 may be trained to generate and optimize the offer and route plan pairs using a supervised or semi-supervised training approach. The match generator 130 may be trained using historical data. The match generator 130 may be executed using a set of offers and a set of route plans to generate predicted pairs which are compared to actual pairs of the set of offers and the set of route plans (e.g., human-generated pairs). The match generator 130 may be updated based on a difference between the predicted pairs and the actual pair. In some implementations, the match generator 130 may be trained based on delivery statistics resulting from implementation by drivers of generated offer and route plan pairs. In an example, the match generator 130 is updated using delivery times and delivery durations resulting from implementation of offer and route plan pairs generated by the match generator 130. In this way, the match generator 130 can learn from historical data and/or the consequences of its own output.

The match generator 130 may pass the offer and route plan pairs and/or the route plans 125 to the offer generator 110. The offer generator 110 may dynamically generate and update the offers 115 based on the offer and route plan pairs and/or the route plans 125. The updated offers 115 may be provided as input to the match generator 130 which dynamically generates and updates the offer and route plan pairs. In this way, the offers 115 are dynamically generated and updated in a cyclical manner. Similarly, the match generator 130 may pass the offer and route plan pairs and/or the offers 115 to the route plan generator 120. The route plan generator 120 may dynamically generate and update the route plans 125 based on the offer and route plan pairs and/or the offers 115. The updated route plans 125 may be provided as input to the match generator 130 which dynamically generates and updates the offer and route plan pairs. In this way, the route plans 125 are dynamically generated and updated in a cyclical manner.

In some implementations, the offers 115, the route plans 125, and the offer and route plan pairs are updated sequentially. In an example, the offer and route plan pairs are generated, the offers 115 are updated based on the offer and route plan pairs, the offer and route plan pairs are updated based on the offers 115, and the route plans 125 are updated based on the updated offer and route plan pairs and the updated offers 115. In some implementations, the offers 115 and the route plans 125 are updated in parallel. In an example, the offer and route plan pairs are generated, the offers 115 and the route plans 125 are each updated based on the offer and route plan pairs, the offer and route plan pairs are updated based on the updated offers 115 and updated route plans 125, and so on. In some implementations, the offers 115, the route plans 125, and the offer and route plan pairs are updated using a combination of sequential and parallel updates. In this way, the offers 115, the route plans 125, and the offer and route plan pairs are dynamically generated and updated in order to improve and optimize the offers 115, the route plans 125, and the offer and route plan pairs.

In some implementations, dynamically generating and updating the offers 115 and the route plans 125 includes generating new offers 115 and/or route plans 125. In an example, if not enough offers were initially generated for the package volume of the package data 107, additional offers can be generated. In an example, if too many offers were initially generated, one or more offers can be deleted and/or one or more route plans can be split to be mapped to different offers.

Each of the offers 115, the route plans 125, and the offer and route plan pairs may be updated as soon as they are initially generated and/or as soon as updated data is available. In an example, the offers 115 may be updated based on new predicted package data 103, new driver information 105, new/updated offer and route plan pairs, and/or new/updated route plans 125. In an example, the route plans 125 may be updated based on new package data 107, new/updated offer and route plan pairs, and/or new/updated offers 115. In an example, the offer and route plan pairs may be updated based on new/updated offers 115 and/or new/updated route plans 125.

The match generator 130 may provide the offer and route plan pairs to the driver application 150. The match generator 130 may provide the offer and route plan pairs to the driver application 150 based on driver check-in and/or drivers arriving to pick up packages. In some implementations, the match generator 130 may provide the offer and route plan pairs at a predetermined time prior to the drivers arriving to pick up packages in order to inform drivers beforehand of routes they will be driving. Providing the offer and route plan pairs to the driver application 150 may include providing the route plans 125 to the driver application 150 corresponding to offers of the offers 115 which have been accepted by drivers. In an example, providing the offer and route plan pairs to the driver application 150 includes identifying a driver who accepted an offer, identifying, using the offer and route plan pairs, a route plan corresponding to the offer, and sending the route plan to the driver application 150 to be displayed to the driver. In this way, drivers can view and accept the offers 115 before the package data 107 is received and before the route plans 125 are generated, and then deliver packages according to the route plans 125 once the route plans 125 are generated and paired with the accepted offers 115.

The route plans 125 may be delivered as input to a cluster engine 160. The cluster engine 160 may generate clusters of packages based on the route plans 125. The clusters may be used to sort packages for pickup by drivers for delivery. The cluster engine 160 may dynamically update the clusters based on updates to the route plans 125. In some implementations, the dynamic generation and updating of the route plans 125 is constrained by timing requirements of the package sorting process. In this way, the route plans 125 may be dynamically generated and updated for as long as feasible, or until packages need to be physically sorted according to the clusters. The drivers may pick up packages sorted by clusters for delivery using the corresponding route plans 125.

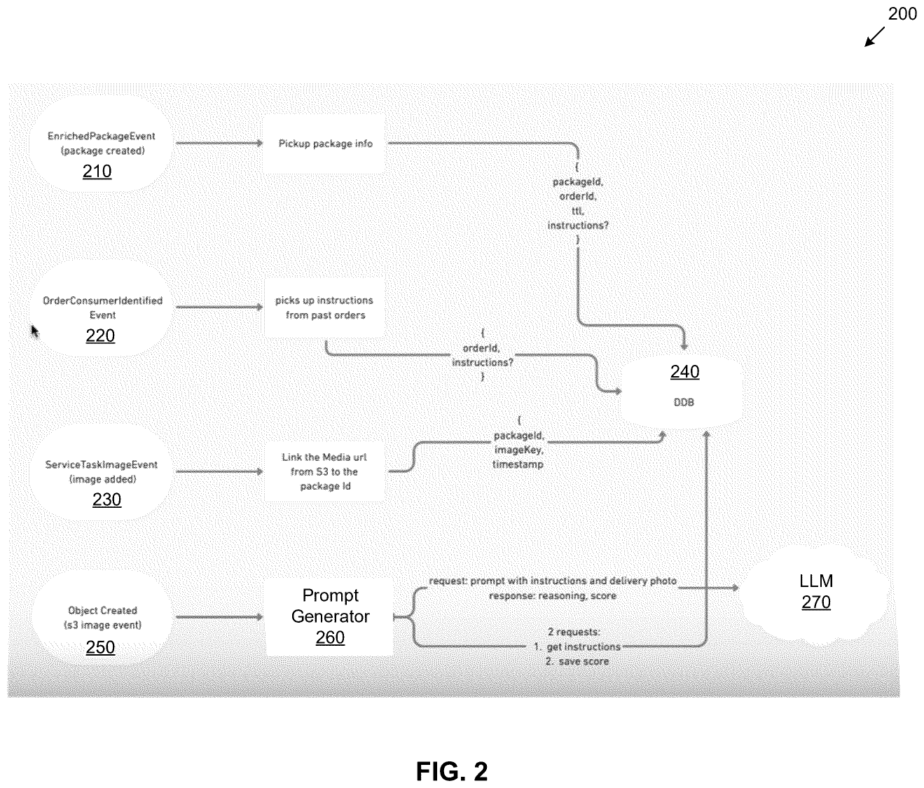

FIG. 2 is a block diagram of an example system 200 for scoring package delivery using a large language model (LLM) 270. The system 200 includes a database 240, a prompt generator 260, and the LLM 270. The database 240 may include data structures to store package data 210, consumer data 220, and an image 230. In some implementations, the database 240 includes pointers or references to the package data 210, the consumer data 220, and the image 230.

The package data 210 may be obtained via a package event that creates the package data. The package data 210 may include an order ID, a package ID, package dimensions, a package weight, a package appearance, a package label, a package contents, package delivery instructions, and other package characteristics. In some implementations, the package data 210 is obtained from the package data 107 of FIG. 1.

The consumer data 220 may include a consumer ID, the order ID, delivery instructions, and other consumer characteristics. The consumer ID may be associated with the package ID. The consumer may be a person to whom the package is to be delivered. The delivery instructions may include standard delivery instructions or historical delivery instructions for the consumer. In this way, if the package data 210 does not include delivery instructions, the delivery instructions of the consumer data 220 can be used. Otherwise, standard delivery instructions may be used.

The image 230 may be a proof-of-delivery image. A proof-of-delivery image may be an image captured by a delivery person to prove that a package was delivered at an address. The image 230 may be stored in a separate database. As noted above, the image 230 may be stored in the database 240 or a pointer or reference of the image 230 may be stored in the database 240. The image 230 may include or be associated with image metadata. The image metadata may include the package ID, a timestamp, a reference to the image 230 in the separate database (e.g., a key of the image for a key-value database), and other image metadata.

In some implementations, the prompt generator 260 accesses the database to retrieve the package data 210, the consumer data 220 and/or the image 230. The prompt generator 260 may retrieve the package data 210, the consumer data 220 and/or the image 230 in response to a prompt generation request. The prompt generation request may be sent to the prompt generator 260 in response to the image 230 being obtained. In some implementations, a delivery object 250 is generated including the package data 210, the consumer data 220 and/or the image 230. In an example, the delivery object includes the image 230 and the delivery instructions from the package data 210 and/or the consumer data 220. The prompt generator 260 may receive as input the delivery object 250.

The prompt generator 260 may receive as input the image 230 and the delivery instructions to generate a prompt for the LLM 270. The prompt generator 260 may generate the prompt based on the delivery instructions and/or the image 230. The prompt generator 260 may parse the delivery instructions to generate the prompt. In an example, the prompt generator 260 identifies package placement instructions within the delivery instructions to generate the prompt. In an example, the prompt generator includes instructions to place a package on a porch in the prompt, and excludes instructions to ring a doorbell from the prompt. The prompt generator 260 may include chain of thought examples in the prompt to guide the LLM 270 in generating the response. The prompt may include the image 230. In an example, the prompt includes the image 230 and text generated by the prompt generator 260 based on the delivery instructions.

The chain of thought examples in the prompt may increase an accuracy of responses from the LLM 270 and cause the LLM 270 to respond in a predetermined format. In some implementations, the chain of thought examples included in the prompt include examples of instructions with corresponding examples of responses. One example of a chain of thought example is “instructions: ‘place by door’, response: {‘score’: 90, ‘reason’: ‘The package is being held by the delivery person near the door, but has not been placed’, ‘hasPackage’: true}.” Another example of a chain of thought example is “instructions: ‘place near car’, response: {‘score’: 0, ‘reason’: ‘The package is near a door, not a car’, ‘hasPackage’: true}.” Another example of a chain of thought example is “instructions: ‘place on porch’, response: {‘score’: 0, ‘reason’: ‘The photo does not show a package’, ‘hasPackage’: false}.” Another example of a chain of thought example is “instructions: ‘gate code 4033’, response: {‘score’: NA, ‘reason’: ‘the instructions don't pertain to package placement, so cannot be graded’, ‘hasPackage’: true}.” Another example of a chain of thought example is “instructions: ‘place by door, out of sight’, response: {‘score’: 100, ‘reason’: ‘The package is by door. Even though the package is visible in the photo, it is likely out of sight from the street’, ‘hasPackage’: true}.” The chain of thought examples may improve an accuracy and precision of the package delivery scores generated by the LLM 270 and cause the LLM 270 to generate responses using the predetermined response format used in the chain of thought examples. In this way, the responses generated by the LLM 270 are more accurate and are presented in a computer-readable format for further processing.

The LLM 270 generates a delivery score based on the prompt. The delivery score may, based on instructions in the prompt, correspond to a quality of the delivery and/or compliance with the delivery instructions. In an example, the delivery score ranges from zero to one hundred, where a score of zero corresponds to no delivery or a misdelivery (e.g., no package or an incorrect package in the image 230) and a score of one hundred corresponds to a correct delivery (e.g., package delivered according to the delivery instructions). The LLM 270 may generate an explanation or justification of the generated score. The explanation may explain why the delivery score was generated. The explanation may be based on the delivery instructions and may explain how the image 230 illustrates compliance or non-compliance with the delivery instructions.

The prompt generator 260 may receive the response from the LLM 270 including the delivery score and/or the explanation. The prompt generator 260 may send the response to the database 240 to be stored in the database 240. In some implementations, the prompt generator 260 sends the prompt and the response to the database 240 to be stored in the database 240. The response may be used to evaluate delivery of the package, to generate package delivery statistics, to track delivery of the package, and/or to generate alerts to the delivery driver who submitted the image 230 as a proof-of-delivery image.

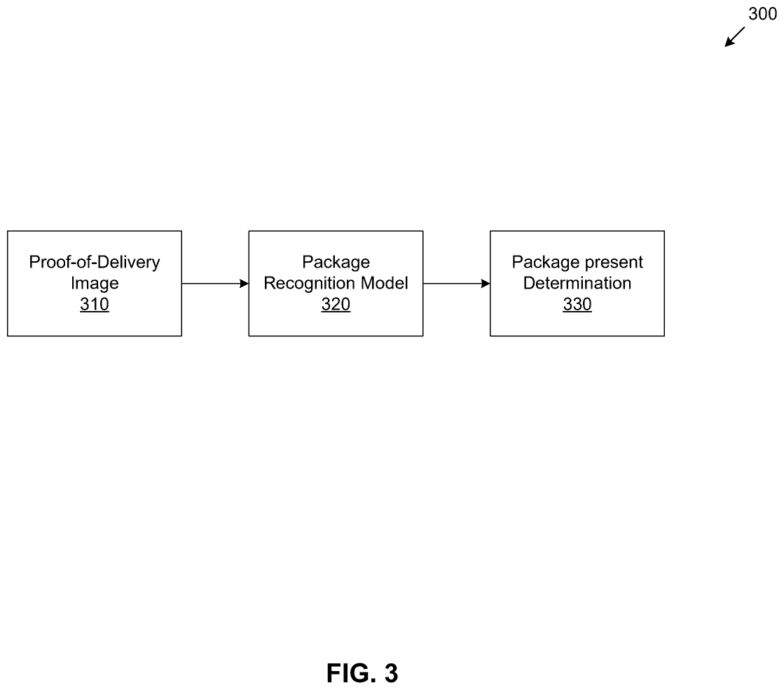

FIG. 3 is a block diagram of an example system 300 for scoring package delivery using a package-recognition model 320. The package-recognition model 320 may be executed using as input a proof-of-delivery image 310 to generate a package present determination 330. The package recognition model 320 may be trained to recognize packages and/or to recognize when packages are present in images. The package recognition model 320 may be trained using supervised training with labeled images. In an example, the package recognition model 320 is trained using a training set including a first set of images including packages and labeled as including packages and a second set of images not including packages and labeled as not including packages. In some implementations, the package recognition model 320 is trained in a first training stage by executing the package recognition model 320 using as input a first training set including images of packages and images without packages to classify the images as including packages or not including packages. The package recognition model 320 can then be trained in a second training stage by executing the package recognition model 320 using as input a second training set including images it incorrectly classified in the first training stage. In this way, the package recognition model 320 can learn from the training data as well as from its own mistakes. The package recognition model 320 can be iteratively trained in several stages of training. In some implementations, the package recognition model 320 is trained until a distance between predictions generated by the package recognition model and ground truth is below a predetermined threshold.

In some implementations, the package recognition model 320 is a contrastive language-image pretraining (CLIP) model trained using natural language descriptions of training images. In this way, the training images can be labeled using natural language descriptions, such as customer responses to historical proof-of-delivery images.

In some implementations, the proof-of-delivery image 310 is stored in the database 240 of FIG. 2. In some implementations, the proof-of-delivery image 310 is the image 230 of FIG. 2. The package present determination 330 may be used to evaluate delivery of the package, to generate package delivery statistics, to track delivery of the package, and/or to generate alerts to the delivery driver who submitted the proof-of-delivery image 310.

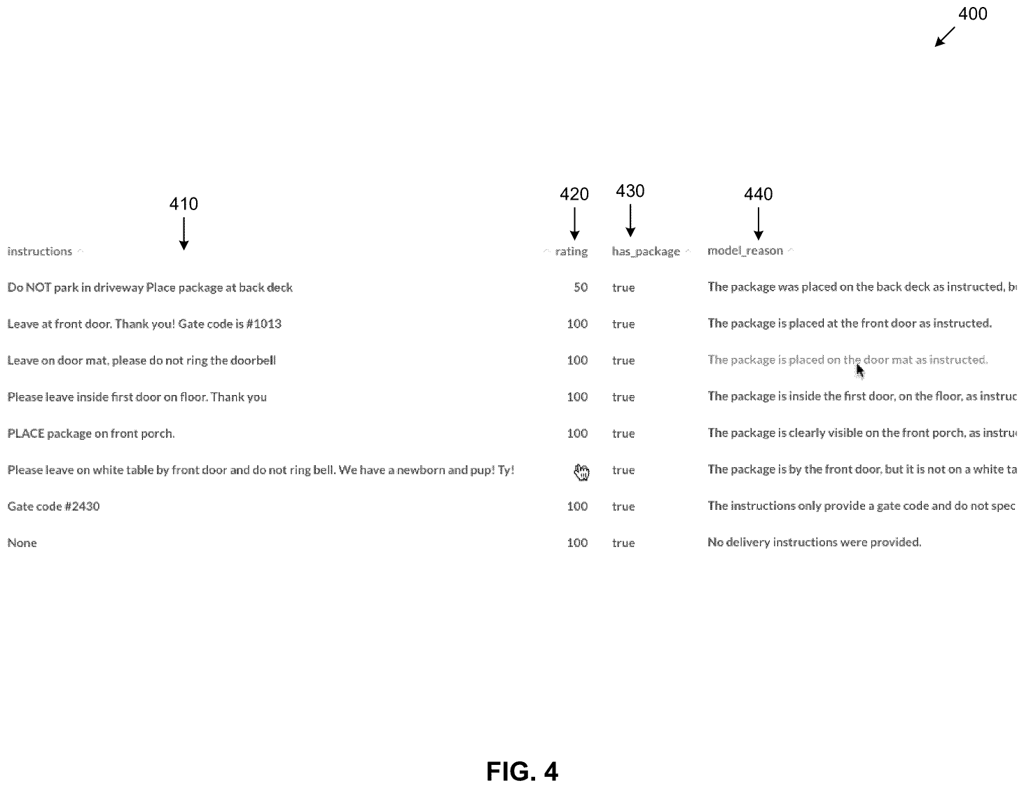

FIG. 4 illustrates an example package delivery scoring data structure 400. The data structure 400 may be an output of the LLM 270 of FIG. 2. The data structure 400 may include delivery instructions 410, delivery scores 420, package present determinations 430, and explanations 440. The delivery instructions 410 may be instructions provided by customers for delivery of packages. The delivery scores 420 may be generated based on compliance with the delivery instructions 410 and/or the package present determinations 430. The explanations 440 may be explanations or justifications for the delivery scores 420. In some implementations, the delivery scores 420, the package present determinations 430, and the explanations 440 are generated by an LLM executed using as input a proof-of-delivery images and the delivery instructions 410. In some implementations, the delivery scores 420, the package present determinations 430, and the explanations 440 are generated by an LLM executed using as input a proof-of-delivery images and the delivery instructions 410, with the package present determinations 430 verified using a package recognition model such as the package recognition model 320 of FIG. 3. In some implementations, the delivery scores 420 and the explanations 440 are generated by an LLM executed using as input a proof-of-delivery images and the delivery instructions 410 and the package present determinations 430 are generated by a package recognition model executed using as input the proof-of-delivery images.

In some implementations, the data structure 400 is used to evaluate delivery of packages, to generate package delivery statistics, to track delivery of packages, and/or to generate alerts to delivery drivers.

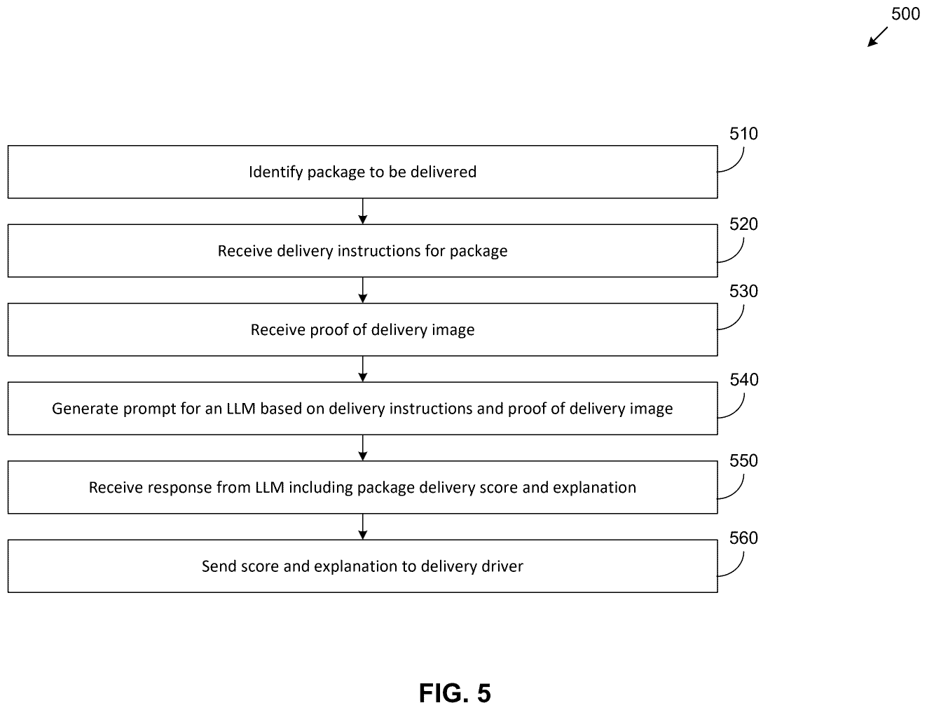

FIG. 5 is a flow chart of an example method 500 for scoring package delivery using a machine-learning model. The method 500 may include more, fewer, or different operations than shown. The operations may be performed in the order shown, in a different order, or concurrently. The method 500 may be performed by the system 200 of FIG. 2 and/or by the prompt generator 260 of FIG. 2.

At operation 510, a package to be delivered is identified. The package may be identified based on an order including a package identifier of the package. In some implementations, the order may be associated with or embodied in a data structure stored in a database. The data structure may include various fields such as an order identifier, customer information, package details, and delivery instructions. The package identifier may be a unique alphanumeric code or barcode associated with the physical package and linked to the order data structure. To identify the package to be delivered, the system may query the database using the order identifier or other relevant information to retrieve the corresponding data structure. The package identifier within this data structure can then be used to uniquely identify and track the physical package throughout the delivery process. This approach allows for efficient retrieval of package information and seamless integration with other components of the delivery system. In an example, the package identifier may be encoded in a barcode scanned at a distribution center. In another example, the package identifier may be encoded in a radio-frequency identification (RFID) tag read by an RFID reader. The package may be identified by querying a database using the package identifier to retrieve package information such as dimensions, weight, or contents.

At operation 520, delivery instructions for the package are received. The delivery instructions may be obtained from various sources, such as customer preferences stored in a database or specific instructions provided with the order. In some implementations, the delivery instructions may be parsed to extract relevant information for package placement. In an example, the delivery instructions may specify “Leave package on front porch” or “Place package inside garage if open.” In another example, the delivery instructions may include time-based preferences such as “Deliver between 2 PM and 5 PM.” The delivery instructions may be associated with the package identifier in a data structure for easy retrieval during the delivery process.

In some implementations, obtaining the delivery instructions may include retrieving the delivery instructions from a database using the package identifier. The database may store delivery instructions associated with various package identifiers, customer preferences, or historical delivery data. A prompt generator may query the database using the package identifier to retrieve the corresponding delivery instructions. In an example, the prompt generator may send a request to the database including the package identifier, and the database may return the associated delivery instructions. The retrieved delivery instructions may include specific placement instructions, time preferences, or special handling requirements for the package. By retrieving the delivery instructions from the database using the package identifier, the system can efficiently access and utilize customer-specific or package-specific delivery preferences without requiring manual input for each delivery. The database can be implemented as a cloud-based database, providing scalable and flexible storage for delivery-related information. In some implementations, the database can be a Simple Storage Service (S3) database hosted on AWS, which can store and retrieve large amounts of data, such as proof-of-delivery images, package data, and consumer data, among others.

At operation 530, a proof-of-delivery image for the package is received. The proof-of-delivery image may be captured by a delivery person using a mobile device or a dedicated imaging device. In some implementations, the proof-of-delivery image may be automatically uploaded to a central server or database upon capture. In an example, the proof-of-delivery image may show the package placed on a doorstep. In another example, the proof-of-delivery image may capture the package being handed directly to a recipient. The proof-of-delivery image may be associated with metadata such as timestamp, geolocation coordinates, or delivery person identifier to provide additional context for the delivery verification process.

The method 500 can include obtaining the proof-of-delivery image by linking a media identifier indicating a location of the proof-of-delivery image in a cloud storage with the package identifier. In some implementations, the media identifier may allow for download of the proof-of-delivery image. The proof-of-delivery image may be stored in a separate database or cloud storage system, such as an S3 bucket on AWS, to efficiently manage large volumes of image data. The method 500 can include associating the media identifier with the package identifier in a data structure, such as the database 240 of FIG. 2. This association may enable rapid retrieval of the proof-of-delivery image when needed for verification or analysis. In an example, when the proof-of-delivery image is captured by a delivery person's mobile device, the image may be automatically uploaded to the cloud storage, and the corresponding media identifier may be generated and linked to the package identifier. The method 500 can include using this link to access the proof-of-delivery image when generating prompts for an LLM, evaluating delivery compliance, or performing other package delivery scoring operations.

The method 500 can include executing a package-recognition model to generate a package-present determination indicating whether a package is present in the proof-of-delivery image. In some implementations, the package-recognition model can be the package recognition model 320 of FIG. 3, which may be executed using the proof-of-delivery image 310 as input to generate the package present determination 330. The package-recognition model can be trained to recognize packages and determine their presence in images using supervised learning techniques with labeled training data. The package-present determination can be used in conjunction with other components of the method 500, such as the LLM-based scoring system, to provide a comprehensive evaluation of package delivery compliance. For example, the package-present determination can be included as part of the input to the LLM when generating the package delivery score, or can be used to verify the LLM's assessment of package presence in the proof-of-delivery image.

At operation 540, a prompt for an LLM is generated based on the delivery instructions and the proof-of-delivery image for the package. The prompt may be constructed to include relevant information from the delivery instructions and a reference to the proof-of-delivery image. In some implementations, the prompt may be formatted using a predefined template to ensure consistency in LLM inputs. In an example, the prompt may include the text of the delivery instructions followed by a question such as “Does the image show compliance with these instructions?” In another example, the prompt may include a description of the ideal package placement extracted from the delivery instructions, along with a request to compare this ideal placement to the actual placement shown in the image. The prompt may include the delivery instructions, the proof-of-delivery image, chain of thought examples, and/or other instructions. In some implementations, the prompt includes a name of the delivery driver who submitted the proof-of-delivery image for the package and/or a delivery history of the delivery driver. In some implementations, the prompt includes a package present determination generated by a package recognition model.

The method 500 can include pre-processing the delivery instructions to generate modified delivery instructions. In some implementations, the prompt generator can analyze and refine the delivery instructions received at operation 520 to extract relevant information for package placement and generate modified delivery instructions. The modified delivery instructions may focus on specific aspects of package placement, such as location, orientation, or concealment, while potentially omitting irrelevant details. For example, the original delivery instructions “Please deliver the package to the front porch, ring the doorbell twice. The package contains a glass vase, so handle with care. We have a dog, but he is friendly” can be modified to “Place package on front porch. Ring doorbell twice.” In this way, the modified delivery instructions retain the essential, actionable information for package placement and notification, while omitting details about package contents, handling instructions, and unrelated information about pets.

The prompt for the LLM can be generated based on the modified delivery instructions. The prompt may include the modified delivery instructions, the proof-of-delivery image received at operation 530, and prompt instructions indicating a format of the response. The prompt instructions may specify the desired format and content of the LLM's response, such as requesting a numerical score, a textual explanation, or both. In an example, the prompt may include modified instructions focusing solely on package placement, such as “Place package on front porch, out of sight from street,” along with the proof-of-delivery image and instructions for the LLM to provide a score and explanation in a specific format. By including the modified delivery instructions, the proof-of-delivery image, and format instructions in the prompt, the method 500 can guide the LLM to generate more focused and consistent responses for evaluating package delivery compliance.

The method 500 can include verifying that the response from the LLM follows a predetermined format specified in the prompt. In some implementations, the prompt generator 260 can include a template for the format of the response in the prompt instructions. The template can specify the structure and content expected in the LLM's response, such as a numerical score followed by a textual explanation. For example, the template may require the response to include a “score” field with a numerical value between 0 and 100, and a “reason” field with a textual explanation of the score. The method 500 can include analyzing the response received from the LLM to ensure compliance with the specified format. In some implementations, the method 500 can include parsing the response to extract the score and explanation, and comparing the extracted elements to the expected format. If the response does not conform to the specified format, the method 500 can include generating an error message or requesting a new response from the LLM.

In some implementations, the response template can specify a JSON-like structure with predefined fields, such as {“score”:, “reason”:, “package_present”:}. The method 500 can include verifying that the response from the LLM adheres to this template by parsing the response and checking that each field contains the expected data type. For example, a valid response following the template may be {“score”: 95, “reason”: “The package is placed on the front porch as instructed, but is slightly visible from the street”, “package_present”: true}, which is verified as containing an integer score between 0 and 100, a non-empty string explanation, and a boolean value for package presence.

At operation 550, a response is received from the LLM including a package delivery score and an explanation of the package delivery score. The package delivery score may be a numerical value representing the degree of compliance with the delivery instructions. In some implementations, the explanation may provide a detailed rationale for the assigned score, referencing specific elements of the delivery instructions and the proof-of-delivery image. In an example, the response may include a score of 90 out of 100 with an explanation stating “The package is placed on the front porch as instructed, but is partially visible from the street.” In another example, the response may include a score of 100 with an explanation stating “The package is correctly placed inside the open garage, fully complying with the delivery instructions.” In some implementations, the response includes a package present determination. In some implementations, the response is included in the data structure 400 of FIG. 4.

The method 500 can utilize various types of machine-learning models to generate the response, including multi-modal large language models (LLMs), convolutional neural networks (CNNs), or transformer-based architectures. In some implementations, a multi-modal LLM can be trained to process both text and image inputs simultaneously, enabling comprehensive analysis of the delivery instructions and proof-of-delivery image. For example, a vision-language model such as CLIP (Contrastive Language-Image Pre-training) can be fine-tuned on a dataset of delivery instructions paired with proof-of-delivery images. The CLIP model can learn to align textual descriptions with visual features, allowing the model to generate accurate package delivery scores and explanations based on the correspondence between the delivery instructions and the image content. In an example, the CLIP model can receive as input the textual delivery instructions “Place package on front porch, out of sight from street” along with the proof-of-delivery image, and generate a response that evaluates the package placement based on both the textual and visual information.

At operation 560, the score and explanation are sent to a delivery driver who submitted the proof-of-delivery image. The explanation may include text reasoning that explains why the score as assigned. In some implementations, the response includes the package delivery score without the justification. In some implementations, the response includes the explanation without the package delivery score. The score and explanation may be transmitted to a mobile device or application used by the delivery driver. In some implementations, the score and explanation may be displayed immediately after the proof-of-delivery image is submitted, providing real-time feedback to the delivery driver. In an example, the delivery driver may receive a notification stating “Delivery Score: 95/100. Great job placing the package as instructed. Consider angling the package slightly to improve concealment.” In another example, the delivery driver may receive a message saying “Delivery Score: 80/100. Package visible in image, but not placed according to instructions. Please review delivery notes for future deliveries.” In some implementations, the score and explanation are modified before being sent to the delivery driver. In an example, the score may be normalized against other delivery scores. In some implementations, the score and explanation are stored in a database and an aggregate delivery evaluation based on the score and explanation of a plurality of deliveries is sent to the delivery driver. In an example, the scores and explanations for all deliveries in a day performed by the delivery driver are used to generate an aggregate delivery score and explanation such as “excellent deliveries today! Your deliveries today followed delivery instructions over 90%.”

The method 500 can include modifying the package delivery score based on an indication of relevance of the delivery instructions to the proof-of-delivery image. In some implementations, the response from the LLM at operation 550 can include an assessment of how applicable or relevant the delivery instructions are to the situation depicted in the proof-of-delivery image. For example, the LLM can determine that instructions to “place the package behind a planter” may not be relevant if the proof-of-delivery image shows no planters present at the delivery location. The method 500 can include analyzing this relevance indication and adjusting the package delivery score accordingly. In an example, if the delivery instructions are deemed highly relevant, the original score may be maintained or slightly adjusted. However, if the instructions are found to be less relevant or inapplicable, the method 500 can include applying a scaling factor or adjustment to the score. For instance, if the instructions specify “place package in mailbox” but the proof-of-delivery image shows no mailbox visible, the method 500 can include reducing the score or applying a different scoring criteria more appropriate to the actual delivery circumstances. This relevance-based modification can provide a more nuanced and context-aware evaluation of the package delivery, accounting for situations where strict adherence to potentially irrelevant instructions may not be possible or practical.

In some implementations, the method 500 can include transmitting the package delivery score to the mobile device of the delivery driver only after verifying that the response follows the format of the response from the template. This verification process can help ensure consistency and reliability in the package delivery scoring system, facilitating easier interpretation and use of the LLM's outputs.

In some implementations, the method 500 can include generating a data structure based on the response received from the large language model (LLM). The data structure may include the package delivery score and the explanation supporting the package delivery score. For example, the data structure may be similar to the data structure 400 illustrated in FIG. 4, which can include fields for delivery instructions 410, delivery scores 420, package present determinations 430, and explanations 440. The method 500 can further include storing the generated data structure in a database. In some implementations, the database may be the database 240 of FIG. 2, or another database configured to store delivery-related information. By storing the data structure in the database, the method 500 can provide a persistent record of delivery evaluations, which may be used for various purposes such as generating delivery statistics, tracking delivery performance over time, or providing historical context for future deliveries.

The method 500 can include receiving user input regarding the package delivery score and updating a prompt generator to generate prompts for the large language model in response to the user input. In some implementations, after sending the score and justification to the delivery driver in operation 560, the method 500 can include receiving feedback from the delivery driver or a supervisor regarding the accuracy or appropriateness of the package delivery score. The user input can include corrections to the score, additional context about the delivery circumstances, or suggestions for improving the scoring criteria. Based on this user input, the method 500 can update the prompt generator used in operation 540 to refine the prompts generated for the large language model. For example, if user input indicates that certain delivery instructions are commonly misinterpreted, the prompt generator can be updated to provide more specific guidance or examples related to those instructions in future prompts. In some implementations, the method 500 can incorporate the user input into a machine learning model that continuously improves the prompt generation process. This iterative feedback loop can enhance the accuracy and relevance of the package delivery scoring system over time, adapting to changing delivery conditions and user expectations.

The method 500 can include receiving user input regarding the package delivery score from users who provided the delivery instructions. In some implementations, after sending the score and justification to the delivery driver in operation 560, the method 500 can include receiving feedback from the users who provided the delivery instructions regarding the accuracy or appropriateness of the package delivery score. The user input can include corrections to the score, additional context about the delivery circumstances, or confirmation of whether the package was delivered according to the provided instructions. Based on this user input, the method 500 can update the prompt generator used in operation 540 to refine the prompts generated for the large language model. For example, if user input indicates that certain delivery locations were incorrectly assessed in the proof-of-delivery images, the prompt generator can be updated to provide more specific guidance or examples related to those delivery locations in future prompts. In some implementations, the method 500 can incorporate the user input into a machine learning model that continuously improves the prompt generation process. The users who provided the delivery instructions can submit feedback through a mobile application or web interface, indicating whether the package was delivered according to the specified instructions and providing additional details about the actual delivery circumstances. This iterative feedback loop can enhance the accuracy and relevance of the package delivery scoring system over time, adapting to changing delivery conditions and user expectations.

The method 500 can be used to evaluate placement of packages or other items in various contexts beyond package delivery. In some implementations, the method 500 can be adapted by replacing key terms to broaden its applicability. For example, the term “delivery instructions” can be replaced with “placement instructions” to encompass a wider range of scenarios where items need to be positioned according to specific guidelines. The term “proof-of-delivery image” can be replaced with “placement image” to refer to any visual documentation of an item's placement, not limited to delivery contexts. Additionally, the term “prompt” can be replaced with “request” to describe the input provided to the machine-learning model in a more general manner. In this way, the method 500 can be applied to evaluate the placement of items in warehouses, retail displays, or other settings where precise positioning is important. In an example, the method 500 can be used to assess the placement of products on store shelves, with the placement instructions specifying desired arrangements and the placement image showing the actual product layout. The machine-learning model can then analyze the request, which includes the placement instructions and placement image, to generate a placement score and explanation. This adaptability allows the method 500 to serve as a versatile tool for evaluating compliance with placement guidelines across various industries and applications.

In an example implementation, a system can identify a package to be transported to a location based on a data structure including an identifier of the package. The package identifier may be a unique alphanumeric code associated with a specific delivery order. The system can query a database using the identifier of the package to retrieve placement instructions for the package. In this example, the placement instructions specify “Place package on front porch, behind potted plant.” After the package is delivered, and a placement image captured by a delivery person, the system can retrieve the placement image for the package in the location using a media identifier indicating a cloud storage location. The placement image shows the package placed on a front porch near a potted plant. The system can execute a request generation engine to generate a request for a machine-learning model using the placement instructions and the placement image for the package. The request generation engine may preprocess the placement instructions to generate modified placement instructions, focusing on key elements such as “front porch” and “behind potted plant.” The request may include these modified placement instructions, the placement image, and request instructions indicating a desired format for the response.

In this example, the system transmits the generated request to a multi-modal large language model (LLM) trained to receive as input a combination of text data and image data. The LLM can analyze the placement instructions and the visual content of the placement image simultaneously to evaluate the package placement. The system can receive a response from the machine-learning model including a package placement score based on a position of the package. The response may include a score of 90 out of 100 and text supporting the package placement score, such as “The package is placed on the front porch as instructed, but is only partially concealed by the potted plant.”

In this example, the system can execute a package-recognition model to generate a package-present determination indicating whether a package is present in the placement image. This determination can be used to verify the LLM's assessment or as additional input for the scoring process. The system can verify that the response follows the format of the response from a template specified in the request instructions. This verification can help ensure consistency and reliability in the package placement scoring system. The system can transmit the package placement score to a mobile device of a transport agent corresponding to the package. The transport agent may receive a notification on their mobile device with the score and supporting text, providing immediate feedback on their package placement performance.

In this example, the system generates a placement data structure including the package placement score and the supporting text, and store this data structure in a database for future reference and analysis. The system may also receive user input regarding the package placement score, either from the transport agent or from users who provided the placement instructions. This feedback can be used to update the request generator, refining the prompts generated for the machine-learning model and improving the accuracy of the package placement scoring system over time.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method, comprising:
identifying a package to be transported to a location based on a data structure including an identifier of the package;
querying a database using the identifier of the package to retrieve placement instructions for the package;
retrieving a placement image for the package in the location using a media identifier indicating a cloud storage location;
executing a request generation engine to generate a request for a machine-learning model using the placement instructions and the placement image for the package;
transmitting the generated request to the machine-learning model;
receiving a response from the machine-learning model including a package placement score based on a position of the package; and
transmitting the package placement score to a mobile device of a transport agent corresponding to the package.

2. The method of claim 1, wherein the response from the machine-learning model includes the package placement score and text supporting the package placement score.

3. The method of claim 2, further comprising:
generating a placement data structure including the package placement score and the supporting text; and
storing the placement data structure in a database.

4. The method of claim 2, wherein the text includes an indication of compatibility of the placement instructions with the placement image, the method further comprising modifying the package placement score according to the indication of compatibility.

5. The method of claim 1, wherein the machine-learning model is a multi-modal large language model (LLM) trained to receive as input a combination of text data and image data.

6. The method of claim 1, further comprising executing a package-recognition model to generate a package-present determination indicating whether a package is present in the placement image.

7. The method of claim 1, further comprising pre-processing the placement instructions to generate modified placement instructions, wherein the request includes the modified placement instructions, the placement image, and request instructions indicating a format of the response.

8. The method of claim 7, wherein the format of the response includes a request for the package placement score and text supporting the package placement score, the request including a template for the format of the response.

9. The method of claim 8, further comprising verifying that the response follows the format of the response from the template, wherein transmitting the package placement score to the mobile device of the placement agent is responsive to verifying that the response follows the format of the response from the template.

10. The method of claim 1, further comprising:
receiving user input regarding the package placement score; and
updating a request generator to generate requests for the machine-learning model in response to the user input.

11. A non-transitory, computer-readable medium including instructions which, when executed by one or more processors, cause the one or more processors to:
identify a package to be transported to a location based on a data structure including an identifier of the package;
query a database using the identifier of the package to retrieve placement instructions for the package;
retrieve a placement image for the package in the location using a media identifier indicating a cloud storage location;
generate a request for a machine-learning model using the placement instructions and the placement image for the package;
transmit the generated request to the machine-learning model;
receive a response from the machine-learning model including a package placement score based on a position of the package; and
transmit the package placement score to a mobile device of a placement agent corresponding to the package.

12. The non-transitory, computer-readable medium of claim 11, wherein the response from the machine-learning model includes the package placement score and text supporting the package placement score.

13. The non-transitory, computer-readable medium of claim 12, wherein the instructions cause the one or more processors to:
generate a placement data structure including the package placement score and the supporting text; and
store the placement data structure in a database.

14. The non-transitory, computer-readable medium of claim 12, wherein the text includes an indication of compatibility of the placement instructions with the placement image, the non-transitory, computer-readable medium further comprising modifying the package placement score according to the indication of compatibility.

15. The non-transitory, computer-readable medium of claim 11, wherein the machine-learning model is a multi-modal large language model (LLM) trained to receive as input a combination of text data and image data.

16. The non-transitory, computer-readable medium of claim 11, wherein the instructions cause the one or more processors to execute a package-recognition model to generate a package-present determination indicating whether a package is present in the placement image.

17. The non-transitory, computer-readable medium of claim 11, wherein the instructions cause the one or more processors to preprocess the placement instructions to generate modified placement instructions, and wherein the request includes the modified placement instructions, the placement image, and request instructions indicating a format of the response.

18. The non-transitory, computer-readable medium of claim 17, wherein the format of the response includes a request for the package placement score and text supporting the package placement score, the request including a template for the format of the response.

19. The non-transitory, computer-readable medium of claim 18, wherein the instructions cause the one or more processors to verify that the response follows the format of the response from the template, and wherein the instructions cause the one or more processors to transmit the package placement score to the mobile device of the placement agent responsive to verifying that the response follows the format of the response from the template.

20. The non-transitory, computer-readable medium of claim 11, wherein the instructions cause the one or more processors to:
receive user input regarding the package placement score; and
update a request generator to generate requests for the machine-learning model in response to the user input.
